(19) United States
(12) Patent Application Publication
(10) Pub. No.: US 2026/0145892 A1
(43) Pub. Date: May 28, 2026

(54) MEDIUM FEED DEVICE AND RECORDING DEVICE

(71) Applicant: SEIKO EPSON CORPORATION, TOKYO (JP)

(72) Inventors: Masashi OGAWA, SHIOJIRI-SHI (JP); Shinya KAWABATA, SHIOJIRI-SHI (JP); Nobuyuki NISHI, HARA-MURA (JP)

(21) Appl. No.: 19/399,937

(22) Filed: Nov. 25, 2025

(30) Foreign Application Priority Data
Nov. 25, 2024 (JP) 2024-204923

(51) Int. Cl. B65H 3/06; B65H 5/06

(52) U.S. Cl. CPC B65H 3/0669; B65H 3/0638; B65H 5/062; B65H 2404/17

(57) ABSTRACT

A medium feed device includes a feed roller a support member that rotatably supports the feed roller. The feed roller is provided at a free end of a drive shaft with respect to the drive shaft. Assuming that direction that is along an axial direction of the drive shaft and that is from a base end side of the drive shaft toward the free end is a first direction and a direction opposite to the first direction is a second direction, the feed roller is displaceable along the axial direction between an attached position and an attachment and detachment position, which is located in the second direction with respect to the attached position, and, in a state where the feed roller has been moved from the attached position to the attachment and detachment position, the attachment and detachment direction of the feed roller is a direction intersecting the axial direction.

The present application is based on, and claims priority from JP Application Serial Number 2024-204923, filed Nov. 25, 2024, the disclosure of which is hereby incorporated by reference herein in its entirety.

### BACKGROUND

### 1. Technical Field

The present disclosure relates to a medium feed device that feeds a medium and a recording device including the medium feed device.

### 2. Related Art

A recording device represented by a printer or an image reading device represented by a scanner may be configured so that a deteriorated feed roller is replaceable.

The sheet transport device disclosed in JP-A-2022-028485 is configured so that the pickup roller is replaceable. The pickup roller includes a roller core section fitted to an outer peripheral section of a support shaft, and an elastic section formed of rubber, elastomer, or the like provided on an outer peripheral section of the roller core section.

The roller core section includes a roller core body, an engaging claw, an operation section, and a knob section provided so as to be located outside the operation section in a radial direction of the roller core body. The pickup roller is movable along the support shaft by releasing engagement of the engagement claw with the support shaft. The direction of movement of the pick-up roller is away from the base end of the support shaft and, by this, the pick-up roller is separated outward from the free end of the support shaft.

In the sheet transport device described in JP-A-2022-028485, since the pickup roller is configured to be separated outward from the free end of the support shaft, it is necessary to provide a space for the pickup roller to be separated outward from the free end of the support shaft, which leads to an increase in the size of the device.

### SUMMARY

A medium feed device according to the present disclosure for solving the above problem includes a placement section configured to have a medium placed thereon; a feed roller configured to feed, in a feeding direction, the medium placed on the placement section; a drive source of the feed roller; a drive shaft that is a shaft configured to transmit drive force of the drive source to the feed roller, that extends along a width direction intersecting the feeding direction, that has a free end; and a support member configured to rotatably support the feed roller, wherein the feed roller is provided at the free end of the drive shaft, a direction that is along an axial direction of the drive shaft and that is from a base end side of the drive shaft toward the free end is defined as a first direction, and a direction opposite to the first direction is defined as a second direction, the feed roller is configured to be displaceable along the axial direction between an attached position and an attachment and detachment position that is located in the second direction with respect to the attached position, and in a state where the feed roller has been moved from the attached position to the attachment and detachment position, an attachment and detachment direction of the feed roller is a direction intersecting the axial direction.

A recording device according to the present disclosure includes the above-described medium feeding device and a recording section that performs recording on a medium fed by the medium feed device.

### BRIEF DESCRIPTION OF THE DRAWINGS

FIG. 1 is a diagram showing a medium transport path of a printer.

FIG. 2 is a perspective view of a feed roller and its surroundings.

FIG. 3 is a cross-sectional view of the feed roller and its surroundings.

FIG. 4 is a perspective view of the feed roller.

FIG. 5 is a perspective view of a drive shaft.

FIG. 6 is a cross-sectional view of the feed roller and its surroundings.

FIG. 7 is a cross-sectional view of the feed roller and its surroundings.

FIG. 8 is a perspective view of a support member and the drive shaft.

FIG. 9 is a perspective view of the support member.

FIG. 10 is a diagram representing sizes of a bearing section, a second opening section, a sliding section, and an intermediate shaft section.

FIG. 11 is a diagram representing sizes of a second bearing section, a first opening section, a sliding section, and an intermediate shaft section.

FIG. 12 is a diagram representing sizes of an engagement shaft section and a cylinder section.

### DESCRIPTION OF EMBODIMENT

Hereinafter, the present disclosure will be generally described.

A medium feed device according to a first aspect includes a placement section configured to have a medium placed thereon; a feed roller configured to feed, in a feeding direction, the medium placed on the placement section; a drive source of the feed roller; a drive shaft that is a shaft configured to transmit drive force of the drive source to the feed roller, that extends along a width direction intersecting the feeding direction, that has a free end; and a support member configured to rotatably support the feed roller, wherein the feed roller is provided at the free end of the drive shaft, a direction that is along an axial direction of the drive shaft and that is from a base end side of the drive shaft toward the free end is defined as a first direction, and a direction opposite to the first direction is defined as a second direction, the feed roller is configured to be displaceable along the axial direction between an attached position and an attachment and detachment position that is located in the second direction with respect to the attached position, and in a state where the feed roller has been moved from the attached position to the attachment and detachment position, an attachment and detachment direction of the feed roller is a direction intersecting the axial direction.

According to this aspect, since the feed roller is displaceable with respect to the drive shaft between the attached position and the attachment and detachment position located in the second direction with respect to the attached position, and, in a state where the feed roller is moved from the attached position to the attachment and detachment position, the attachment and detachment direction of the feed roller is a direction intersecting the axial direction, it is not necessary to provide a space for the feed roller to come off on the outer side of, that is, in the first direction of, the feed roller located at the attached position, it is possible to suppress an increase in the size of the device, and the degree of freedom of layout is also improved.

A second aspect is an aspect according to the first aspect, wherein the feed roller includes a roller section configured to come into contact with the medium and a shaft section that is located in the second direction with respect to the roller section, that extends in the width direction, and that engages with the drive shaft, the shaft section includes an intermediate shaft section having a diameter smaller than that of the roller section, a sliding section that is located in the second direction from the intermediate shaft section and that has a larger diameter than the intermediate shaft section, and an engagement shaft section that is located in the second direction from the sliding section, that has a smaller diameter than the sliding section, and that extends in the second direction, the drive shaft is configured to transmit the drive force to the engagement shaft section the support member includes a bearing section that rotatably supports the sliding section and a first opening section that is located in the second direction from the bearing section, that opens in a detachment direction of the shaft section, and that has an opening width larger than the diameter of the sliding section, and the sliding section is configured to move from the bearing section to a position facing the first opening section in accordance with displacement of the feed roller from the attached position to the attachment and detachment position.

According to this aspect, when the feed roller is positioned at the attached position, the sliding section is supported by the bearing section, and thus the feed roller can stably rotate. Since the sliding section moves from the bearing section to a position facing the first opening section in accordance with the displacement of the feed roller from the attached position to the attachment and detachment position, the sliding section can be detached through the first opening section.

A third aspect is an aspect according to the second aspect, wherein the intermediate shaft section is configured to move from a position separated in the first direction from the bearing section to the bearing section in accordance with displacement of the feed roller from the attached position to the attachment and detachment position, the bearing section has a second opening section that is an opening section opening in the detachment direction of the shaft section and that has an opening width smaller than the diameter of the sliding section, and the intermediate shaft section has a non-true circle shape so as to have a maximum diameter and a minimum diameter in cross section, and the opening width of the second opening section is smaller than the maximum diameter of the intermediate shaft section and larger than the minimum diameter of the intermediate shaft section.

According to the present aspect, the intermediate shaft section has a non-true circle shape so as to have a maximum diameter and a minimum diameter in a cross section, and the opening width of the second opening section is smaller than the maximum diameter of the intermediate shaft section and larger than the minimum diameter of the intermediate shaft section, and thus the intermediate shaft section can take a state of being attachable and detachable and a state of being not attachable and detachable depending on a rotational phase.

With such a configuration, it is possible to suppress that the feed roller located at the attachment and detachment position will be inadvertently detached.

A fourth aspect is an aspect according to the third aspect, wherein the drive shaft includes a cylinder section into which the engagement shaft section is fitted and the cylinder section has an attachment and detachment opening that opens in a direction intersecting the axial direction.

According to this aspect, since the cylinder section has the attachment and detachment opening that is open in the direction intersecting the axial direction, the engagement shaft section is easily attached to and detached from the drive shaft.

A fifth aspect is an aspect according to the fourth aspect, wherein an outer periphery of the engagement shaft section includes in cross section a first linear section and a second linear section that is parallel to the first linear section, an inner side of the attachment and detachment opening has a first restriction surface that is a surface that faces the first linear section of the engagement shaft section and a second restriction surface that is a surface that faces the second linear section of the engagement shaft section, and the first restriction surface and the second restriction surface transmit torque to the engagement shaft section.

According to this aspect, the first linear section and the second linear section of the engagement shaft section and the first restriction surface and the second restriction surface of the cylinder section serve to stop rotation, so that the engagement shaft section can appropriately receive torque from the cylinder section.

A sixth aspect is an aspect according to the fifth aspect, wherein play between the intermediate shaft section and the second opening section when the intermediate shaft section passes through the second opening section in the attachment and detachment direction is larger than play between the cylinder section and the engagement shaft section.

The shaft section can be attached and detached in the attachment and detachment direction when the opening direction of the attachment and detachment opening and the opening direction of the second opening section coincide with each other. Here, from the viewpoint of the cylinder section transmitting torque to the engagement shaft section, it is desirable that play between the cylinder section and the engagement shaft section be as small as possible. However, in this case, if the play between the intermediate shaft section and the second opening section when the intermediate shaft section passes through the second opening section in the attachment and detachment direction is equal to or less than the play between the cylinder section and the engagement shaft section, the shaft section cannot be attached or detached unless the opening direction of the attachment and detachment opening and the opening direction of the second opening section strictly coincide with each other.

However, according to this aspect, since the play between the intermediate shaft section and the second opening section when the intermediate shaft section passes through the second opening section in the attachment and detachment direction is larger than the play between the cylinder section and the engagement shaft section, the shaft section can be attached and detached even when the opening direction of the attachment and detachment opening and the opening direction of the second opening section do not strictly coincide with each other, and the shaft section is easily attached and detached.

A seventh aspect is an aspect according to the first aspect, further including a restriction member configured to restrict displacement of the feed roller from the attached position to the attachment and detachment position.

According to this aspect, since the restriction member that restricts displacement of the feed roller from the attached position to the attachment and detachment position is provided, it is possible to suppress the feed roller from being inadvertently displaced from the attached position to the attachment and detachment position and coming off.

Note that this aspect is not limited to the above first aspect and may be according to any of the above second to sixth aspects.

An eighth aspect is an aspect according to the seventh aspect, wherein the restriction member is attachable to and detachable from the support member.

According to this aspect, in the configuration in which the restriction member is attachable to and detachable from the support member, the operational effect of the seventh aspect described above is obtained.

A recording device according to a ninth aspect includes the medium feed device according to any one of the first to eighth aspects, and a recording section that performs recording on the medium fed by the medium feed device.

According to this aspect, in the recording device, the operational effect of any one of the first to eighth aspects described above is obtained.

Hereinafter, the present disclosure will be described in detail.

Hereinafter, an ink jet printer 1, which is an example of a recording device that performs recording on a medium, will be described. Hereinafter, the inkjet printer 1 is simply referred to as printer 1.

Note that an X-Y-Z coordinate system illustrated in each drawing is an orthogonal coordinate system, and a direction in which an arrow is directed is a +direction, and the opposite direction is a −direction. The X-axis direction is the width direction of the device, and is the width direction of the medium on which recording is performed. When viewed from the operator of the printer 1, the +X direction is the left side and the −X direction is the right side. Hereinafter, the X-axis direction may be referred to as a medium width direction or simply a width direction.

The +X direction is an example of a first direction, which is a direction from a base end side of a drive shaft 50 (to be described later) toward a free end, and the −X direction is an example of a second direction, which is opposite to the first direction.

The Y-axis direction is the device depth direction and is a direction along a medium transport direction during recording. The +Y direction is a direction from the rear surface to the front surface of the device, and the −Y direction is a direction from the front surface to the rear surface of the device. In present embodiment, among the side surfaces constituting the periphery of the printer 1, the side surface in the +Y direction is the device front surface, and the side surface in the −Y direction is the device rear surface.

The Z-axis direction is a direction along the vertical direction and is the device height direction. The +Z direction is a vertically upward direction, and the −Z direction is a vertically downward direction.

Note that in the following, the direction in which the medium is sent is referred to as “downstream” and the opposite direction is referred to as “upstream” in some cases.

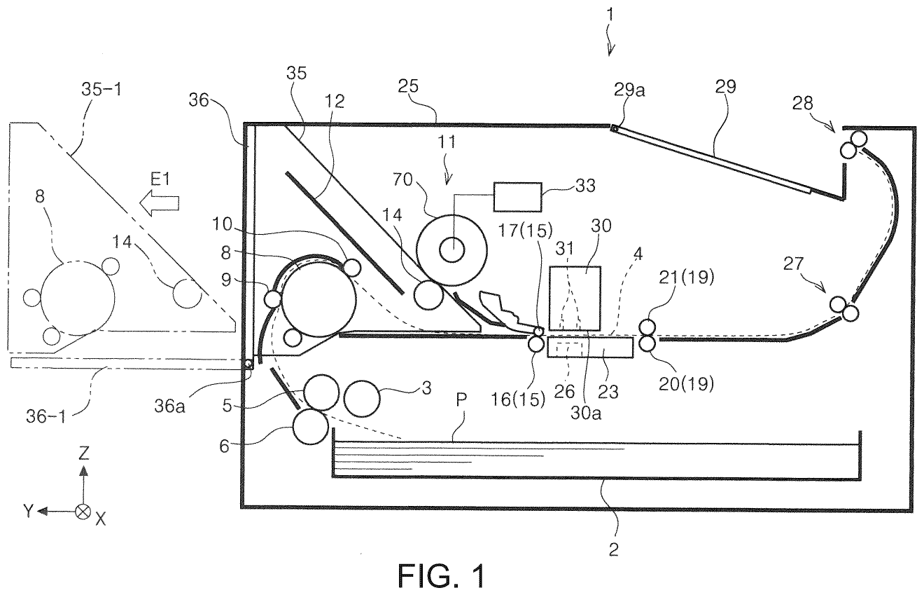

Hereinafter, the medium transport path of the printer 1 will be described with reference to FIG. 1. The medium in the printer 1 is transported along a medium transport path 4 indicated in broken line.

More specifically, the printer 1 includes a medium accommodation cassette 2 at the bottom of the device. The reference numeral P indicates medium stored in the medium accommodation cassette 2. An example of the medium is recording sheets. The medium accommodation cassette 2 is provided so as to be attachable to and detachable from the front side of the device.

A pickup roller 3 driven by a motor (not illustrated) is provided on the upper section of the medium accommodation cassette 2. The pickup roller 3 is configured to advance and retreat with respect to the medium accommodated in the medium accommodation cassette 2 and sends out the medium from the medium accommodation cassette 2 in the +Y direction by rotating in contact with the medium accommodated in the medium accommodation cassette 2.

A feed roller 5 driven by a motor (not illustrated) and a separation roller 6 to which rotational torque is applied by a torque limiter (not illustrated) are provided downstream of the medium accommodation cassette 2. The medium sent out from the medium accommodation cassette 2 is separated by being nipped by the feed roller 5 and the separation roller 6 and is further sent downstream.

An inversion roller 8 driven by a motor (not illustrated) is provided downstream of the feed roller 5 and the separation roller 6. A first nip roller 9 and a second nip roller 10 are provided around the inversion roller 8, and the medium is nipped by the inversion roller 8 and the first nip roller 9, further nipped by the inversion roller 8 and the second nip roller 10 and transported. The transport direction of the medium is inverted from the +Y direction to the −Y direction by the inversion roller 8, and the medium is transported downstream.

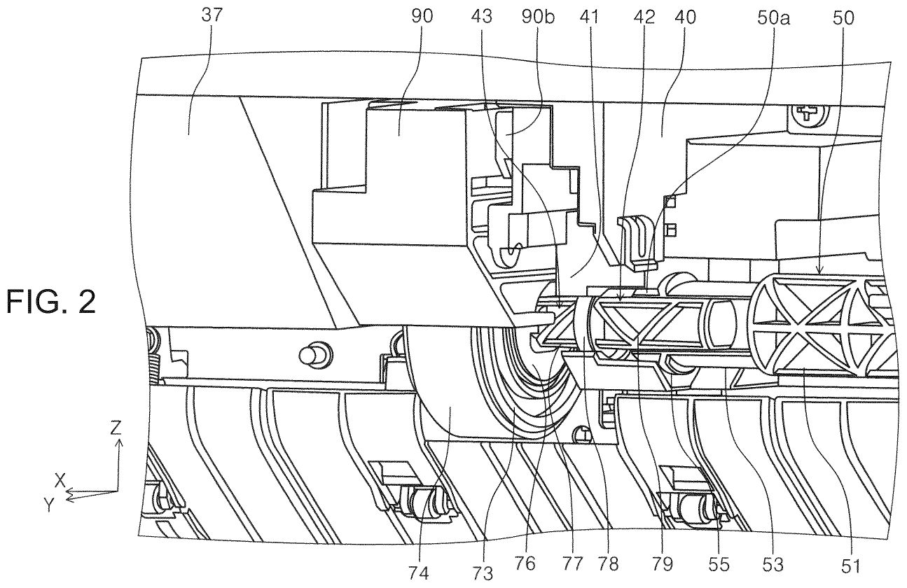

The printer 1 includes a medium feeding path from the medium placement section 12 in addition to the medium feeding path from the medium accommodation cassette 2. A medium feed device 11 is a device that feeds the medium from the medium placement section 12. The medium feed device 11 includes a medium placement section 12, a feed roller 70, and a drive motor 33. As configuration related to the feed roller 70, the medium feed device 11 includes a support member 40 (refer to FIG. 2) and a drive shaft 50 (refer to FIG. 2) (to be described later).

The medium placement section 12 supports the medium in an inclined posture, and the supported medium is transported to the first transport roller pair 15 by the feed roller 70 driven by the drive force of the drive motor 33. Reference numeral 14 denotes a separation roller to which rotational torque is applied by a torque limiter (not illustrated). The feed roller 70 will be further described later.

A first transport roller pair 15 including a drive roller 16 driven by a motor (not illustrated) and a driven roller 17 capable of being driven to rotate is provided downstream of the inversion roller 8. The driven roller 17 is pressed toward the drive roller 16 by a pressing member (not illustrated).

A line head 30 constitutes a recording section that performs recording on the medium. The line head 30 is an example of a recording head that performs recording by ejecting ink, which is an example of a liquid, onto the medium. The line head 30 is a liquid ejection head in which a plurality of nozzles 31 that eject ink are arranged so as to cover the entire area in the medium width direction. The line head 30 is elongated in the medium width direction and is configured as a liquid ejection head capable of recording on the entire medium width area without moving in the medium width direction.

Reference numeral 42a denotes a head surface that faces the medium. A head surface 30a can also be referred to as a liquid ejection surface or a nozzle surface. The head surface 30a is parallel to the medium transport direction, that is, the Y-axis direction, at a position facing the line head 30. The head surface 30a is parallel to the X-Y plane.

The printer 1 includes an ink accommodation section (not illustrated) and the ink ejected from the line head 30 is supplied from the ink accommodation section to the line head 30 via an ink tube (not illustrated).

A facing section 23 is provided at a position facing the head surface 30a of the line head 30. The name of the facing section may be replaced with “platen”. The facing section 23 according to the present embodiment includes a shutter (not illustrated) that can be opened and closed, and the facing section 23 supports the medium in a state where the shutter is closed. Hereinafter, the gap between the facing section 23 and the head surface 30a may be referred to as a platen gap.

A cap section 26 is provided below the shutter, and when the shutter is opened, the cap section 26 and the head surface 30a can face each other. The line head 30 is provided so as to be able to be raised and lowered by the power of a motor (not illustrated), and the cap section 26 can cover the head surface 30a by the line head 30 lowering in a state where the shutter is open.

A second transport roller pair 19 including a drive roller 20 driven by a motor (not illustrated) and a driven roller 21 that can be driven to rotate is provided downstream of the line head 30. The medium that was recorded on is transported downstream by the second transport roller pair 19.

The driven roller 21 is pressed toward the drive roller 20 by a pressing member (not illustrated).

A third transport roller pair 27 is provided downstream of the second transport roller pair 19, and a discharge roller pair 28 is provided downstream of the third transport roller pair 27. A portion between the third transport roller pair 27 and the discharge roller pair 28 is configured as a face down discharge path, and the medium that was recorded on is discharged to a discharge tray 29 by the discharge roller pair 28 in a state where the most recently recorded surface faces downward.

The discharge tray 29 is provided so as to be rotatable around a rotation shaft 29a with respect to a housing 25, which constitutes the outer shell of the printer 1. The user can access the inside of the printer 1 by opening the discharge tray 29. For example, in a case where a medium becomes stuck in the medium transport path 4, that is, when a jam occurs, the jammed medium can be removed by opening the discharge tray 29.

A cover 36 is provided on the front surface of the device. The cover 36 can be opened as indicated by reference numeral 36-1 by rotating about a pivot shaft 36a at the lower end section. Inside the cover 36, a transport unit 35 is provided so as to be attachable to and detachable from the housing 25. The transport unit 35 is a unit including the inversion roller 8, the separation roller 14, and the like. The transport unit 35 can be pulled out in a direction indicated by an arrow E1 in a state where the cover 36 is opened. Reference numeral 35-1 denotes the transport unit 35 that has been pulled out. By pulling out the transport unit 35, the inside of the device including the feed roller 70 can be exposed, and jammed medium can be removed. The feed roller 70 can be replaced by pulling out the transport unit 35. Hereinafter, replacement of the feed roller 70 will be described with reference to FIG. 2 and subsequent drawings.

FIG. 2 illustrates a state in which the transport unit 35 is removed and the feed roller 70 is exposed. The feed roller 70 is provided at the free end 50a of the drive shaft 50, and is rotatably supported by the support member 40.

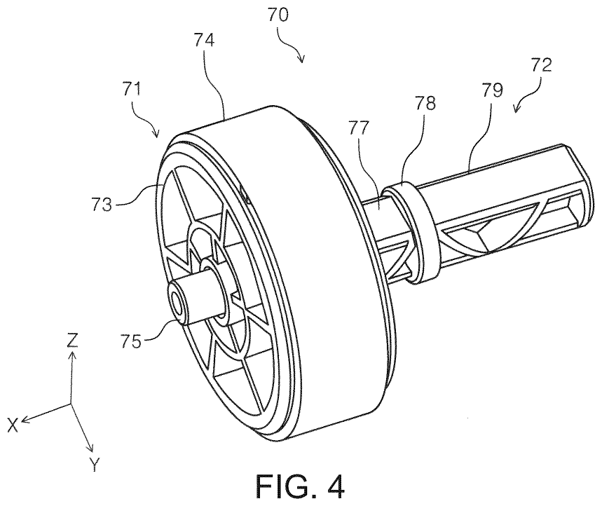

As illustrated in FIG. 4, the feed roller 70 includes a roller section 71 capable of contacting the medium, and a shaft section 72, which is a part that is located in the −X direction with respect to the roller section 71, that extends in the X-axis direction, and that engages with the drive shaft 50.

The roller section 71 includes a roller main body section 73 and an outer peripheral section 74. The roller main body section 73 is formed of a resin material, for example. The outer peripheral section 74 is provided on the roller main body section 73, and is formed of an elastic material such as rubber or elastomer, for example.

The shaft section 72 is formed of a resin material, for example. The shaft center line (not illustrated) of the shaft section 72 is parallel to the X-axis direction. The shaft section 72 includes an intermediate shaft section 77 that has a diameter smaller than that of the roller section 71, a sliding section 78 that is located in the −X direction with respect to the intermediate shaft section 77 and that has a diameter larger than that of the intermediate shaft section 77, and an engagement shaft section 79 that is located in the −X direction with respect to the sliding section 78, that has a diameter smaller than that of the sliding section 78, and that extends in the −X direction. The drive shaft 50 transmits a drive force to the engagement shaft section 79.

Note that in the present specification, the term “diameter” means not only the diameter of a true circle but also the size of a non-true circle in the radial direction. The size in the radial direction is, for example, the size in a case where the size of the shaft in the radial direction is measured with a caliper. In this case, if the shaft has a non-true circle shape in cross section, the size changes when the shaft is rotated. In this case, the largest size is referred to as a “maximum diameter”, and the smallest size is referred to as a “minimum diameter”.

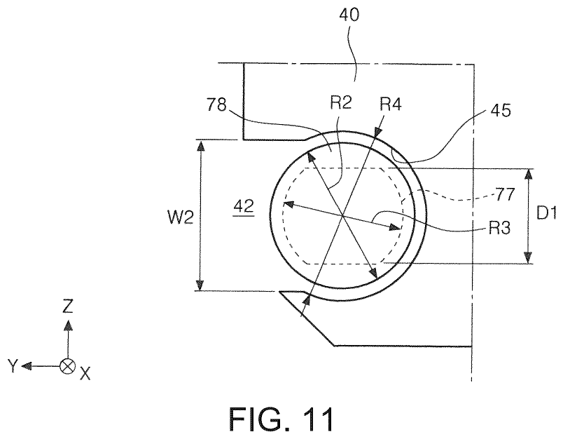

In the present embodiment, the intermediate shaft section 77 and the engagement shaft section 79 have non-true circle shapes in cross section, and the sliding section 78 has a true circle shape in cross section. In the present embodiment, the intermediate shaft section 77 and the engagement shaft section 79 have the same cross-sectional shape and the same size. In FIG. 11, reference numeral R2 denotes the diameter of the sliding section 78.

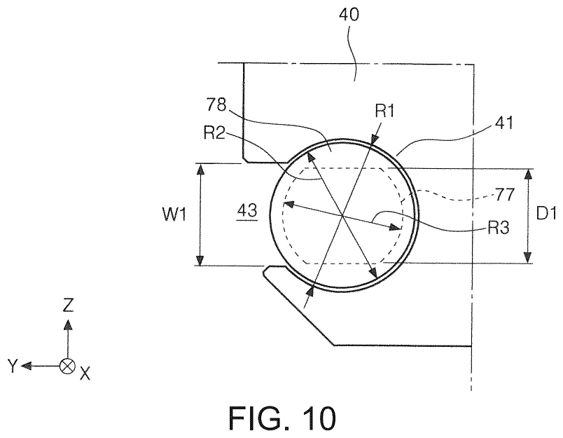

Note that in FIGS. 10 and 11, hatching is omitted to avoid complication of the drawings. FIG. 10 illustrates a relationship between the sliding section 78 and the shaft bearing section 41 when the feed roller 70 is at an attached position X1 (to be described later), and FIG. 11 illustrates a relationship between the sliding section 78 and the first opening section 42 when the feed roller 70 is at an attachment and detachment position X2 (to be described later).

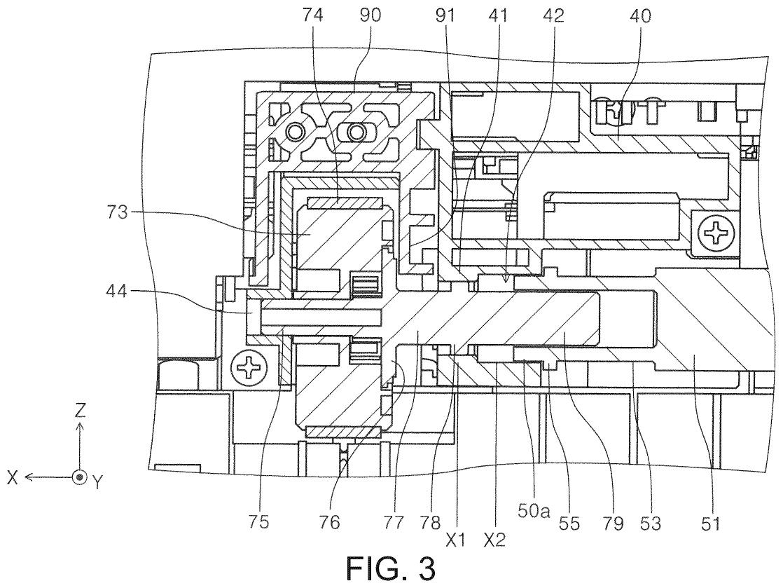

Note that as illustrated in FIG. 3, a flange section 76 is formed on the shaft section 72, and a through shaft 75 is formed so as to extend from the flange section 76 in the +X direction. The through shaft 75 passes through the roller main body section 73. In other words, the roller main body section 73 is provided on the through shaft 75. Note that the roller main body section 73 is fixed by a rotation stopper (not illustrated) so as not to rotate relative to the through shaft 75.

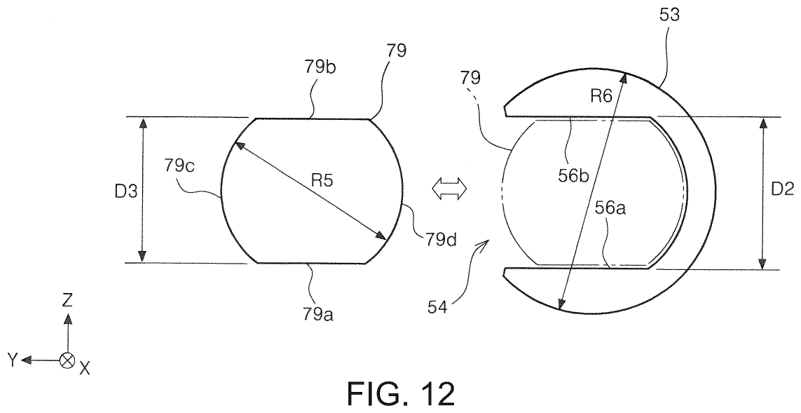

Here, the shapes of the intermediate shaft section 77 and the engagement shaft section 79 will be described with reference to FIG. 12. Note that although FIG. 12 shows the engagement shaft section 79, the intermediate shaft section 77 also has the same shape (refer to FIGS. 10 and 11).

The engagement shaft section 79 forms the shape of a shaft whose cross section is a true circle with cut out sections, and on the outer periphery has, in the cross section, a first linear section 79a and a second linear section 79b that is parallel to the first linear section 79a. The distance between the first linear section 79a and the second linear section 79b is the minimum diameter of the engagement shaft section 79, and is denoted by reference numeral D3. Note that the maximum diameter of the engagement shaft section 79 is the diameter of the circumference indicated by the reference numeral R5. The reference numeral 79c is a first circumference section, and the reference numeral 79d is a second circumference section.

Note that similarly, in FIG. 11, the reference numeral D1 denotes the minimum diameter of the intermediate shaft section 77 and the reference numeral R3 denotes the maximum diameter of the intermediate shaft section 77.

In the present embodiment, the minimum diameter D3 of the engagement shaft section 79 is equal to the minimum diameter D1 of the intermediate shaft section 77, and the maximum diameter R5 of the engagement shaft section 79 is equal to the maximum diameter R3 of the intermediate shaft section 77. Therefore, the outer periphery of the engagement shaft section 79 and the outer periphery of the intermediate shaft section 77 coincide with each other when viewed from the axial direction.

Note that the first circumference section 79c and the second circumference section 79d may be linear sections. That is, the axial cross sections of the engagement shaft section 79 and of the intermediate shaft section 77 are not limited to the shapes illustrated in FIG. 12.

In the present embodiment, the maximum diameter R5 of the engagement shaft section 79 and the maximum diameter R3 of the intermediate shaft section 77 are smaller than the diameter R2 of the sliding section 78.

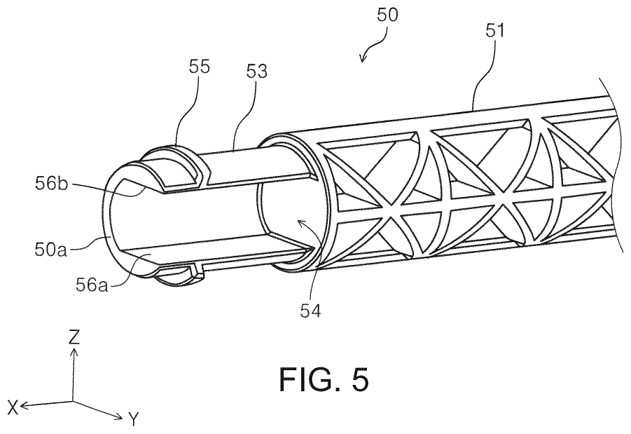

Next, the drive shaft 50 will be described with reference to FIG. 5.

The drive shaft 50 has a base end section 51 and a cylinder section 53, and extends along the X-axis direction. The axial center line (not illustrated) of the drive shaft 50 is parallel to the X-axis direction. In the present embodiment, the entire drive shaft 50 is integrally formed of a resin material.

The base end section 51 receives the drive force of the drive motor 33 at a −X direction end section (not illustrated). The cylinder section 53 is provided in the +X direction with respect to the drive shaft 50. An end section of the cylinder section 53 in the +X direction forms a free end 50a of the drive shaft 50.

The cylinder section 53 has a hollow inside and can receive the engagement shaft section 79 of the shaft section 72 described above. The cylinder section 53 is provided with an attachment and detachment opening 54 that opens in a direction intersecting the axial direction. The attachment and detachment opening 54 is formed along the X-axis direction.

The inside of the cylinder section 53 has a shape that fits with the engagement shaft section 79. As illustrated in FIG. 12, inside the cylinder section 53 are formed a first restriction surface 56a, which is a surface facing the first linear section 79a of the engagement shaft section 79, and a second restriction surface 56b, which is a surface facing the second linear section 79b of the engagement shaft section 79. The first restriction surface 56a and the second restriction surface 56b are parallel to each other. Reference numeral D2 denotes the interval between the first restriction surface 56a and the second restriction surface 56b. The interval D2 is slightly larger than the minimum diameter D3 of the engagement shaft section 79. When the engagement shaft section 79 is fitted to the cylinder section 53, the first restriction surface 56a and the second restriction surface 56b transmit torque to the engagement shaft section 79.

Note that the engagement shaft section 79 can be displaced in the X-axis direction in a state of being fitted to the cylinder section 53. As illustrated in FIG. 5, the cylinder section 53 is formed with a partial flange section 55 in the X-axis direction, that is, in the axial direction.

Next, the support member 40 will be described.

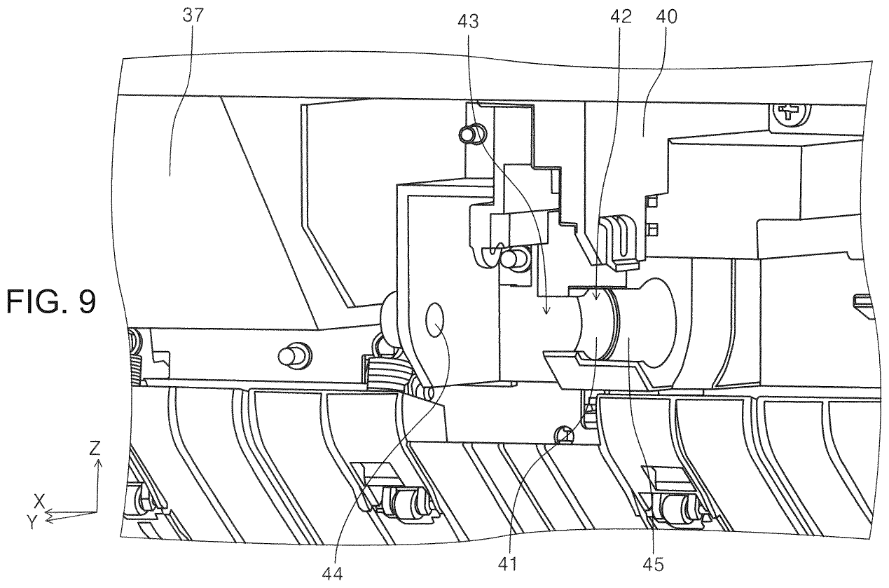

The support member 40 rotatably supports the shaft section 72 of the feed roller 70. As illustrated in FIG. 9, the support member 40 is provided with a bearing section 41, a second bearing section 45, and a support hole 44. The bearing section 41 is a part that rotatably supports the sliding section 78 of the shaft section 72, and is formed with a second opening section 43 that is open in the +Y direction, that is, in the detachment direction of the shaft section 72.

In FIG. 10, the reference numeral W1 indicates the opening width of the second opening section 43. In FIG. 10, reference numeral R1 denotes the inner diameter of the shaft bearing section 41.

The inner diameter R1 of the bearing section 41 is larger than the diameter R2 of the sliding section 78. The opening width W1 of the second opening section 43 is smaller than the diameter R2 of the sliding section 78. Therefore, in a state where the sliding section 78 is axially supported by the bearing section 41, the sliding section 78 does not come off in the +Y direction, that is, in the detachment direction of the shaft section 72.

The inner diameter R1 of the shaft bearing section 41 is larger than the maximum diameter R3 of the engagement shaft section 79. The opening width W1 of the second opening section 43 is smaller than the maximum diameter R3 of the engagement shaft section 79 and also larger than the minimum diameter D1 of the engagement shaft section 79. Therefore, when the phase of the engagement shaft section 79 is in the state illustrated in FIG. 10, the engagement shaft section 79 can be pulled out from the second opening section 43 in the +Y direction.

Next, as illustrated in FIG. 9, the second bearing section 45, which is located in the −X direction with respect to the bearing section 41, is formed with the first opening section 42, which opens in the +Y direction, that is, in the detachment direction of the shaft section 72. In FIG. 11, the reference numeral W2 indicates the opening width of the first opening section 42. In FIG. 11, the reference numeral R4 denotes the inner diameter of the second bearing section 45.

The inner diameter R4 of the second bearing section 45 is larger than the diameter R2 of the sliding section 78. The opening width W2 of the first opening section 42 is larger than the diameter R2 of the sliding section 78. Therefore, in a state where the sliding section 78 has been moved to the second bearing section 45, that is, in a state where the sliding section 78 faces the first opening section 42, the sliding section 78 can be detached in the +Y direction, that is, in the detachment direction of the shaft section 72.

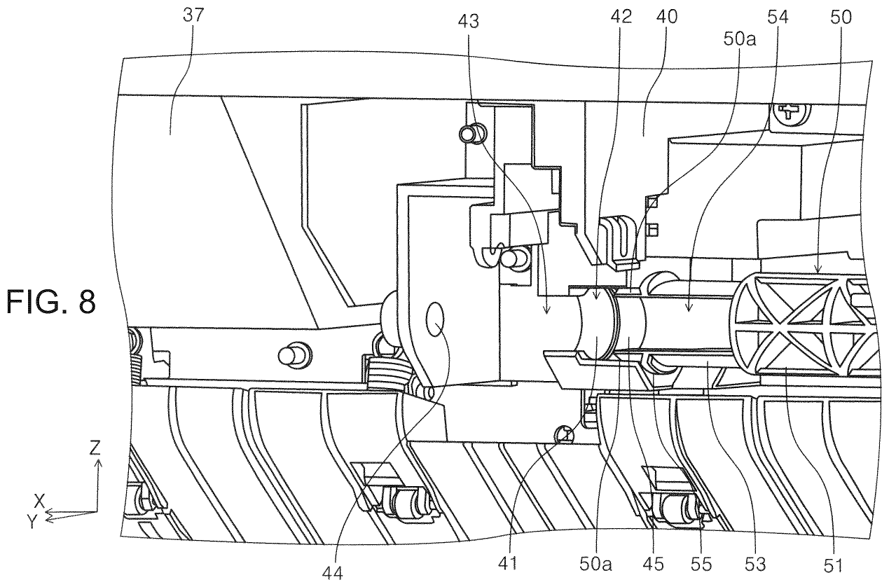

Note that the inner diameter R4 of the second bearing section 45 is larger than a diameter R6 of the cylinder section 53 (refer to FIG. 12). By this, the cylinder section 53 can be fitted to the second bearing section 45 as illustrated in FIG. 8. The position of the free end 50a of the drive shaft 50 is stabilized by inserting the cylinder section 53 into the second bearing section 45.

As illustrated in FIG. 9, the support member 40 is provided with the support hole 44. The inner diameter of the support hole 44 is larger than the outer diameter of the through shaft 75. By this, as illustrated in FIG. 3, the +X direction tip end of the through shaft 75 can be fitted into the support hole 44.

Next, an attached state of the feed roller 70 will be described. FIGS. 2 and 3 illustrate an attached state of the feed roller 70.

In the attached state of the feed roller 70, the feed roller 70 is located at the attached position in the axial direction, that is, in the X-axis direction. In FIG. 3, positions indicated by reference numerals X1 and X2 indicate axial direction positions of the feed roller 70 with reference to the position of the sliding section 78, the position X1 being an attached position and the position X2 being an attachment and detachment position.

When the feed roller 70 is at the attached position X1, the sliding section 78 is supported by the bearing section 41, and the +X direction tip end of the through shaft 75 is fitted into the support hole 44 and is supported by the support hole 44. That is, when the feed roller 70 is at the attached position X1, the shaft section 72 is rotatably supported by the shaft bearing section 41 and the support hole 44 of the support member 40. The engagement shaft section 79 of the shaft section 72 is fitted to the cylinder section 53, and can receive the drive force from the drive shaft 50.

In a case where the feed roller 70 is in the attached position X1, the intermediate shaft section 77 is in a position shifted in the +X direction with respect to the shaft bearing section 41.

The feed roller 70 is displaceable between the attached position X1 and the attachment and detachment position X2, but in a state where a restriction member 90 is attached to the support member 40, the support member 40 restricts displacement of the feed roller 70 in the −X direction and, by this, the feed roller 70 is held at the attached position X1. The restriction member 90 is provided with a restriction section 91. The restriction section 91 comes into contact with the flange section 76 of the shaft section 72 and restricts displacement of the flange section 76 in the −X direction. By this, the feed roller 70 is held at the attached position X1.

Next, a procedure of detaching the feed roller 70 will be described.

When the feed roller 70 is to be removed, first, the restriction member 90 illustrated in FIG. 2 is removed. The restriction member 90 is detachably attached to the support member 40 by a snap fit structure (not illustrated), and the restriction member 90 can be detached from the support member 40 by operating an operation section 90b.

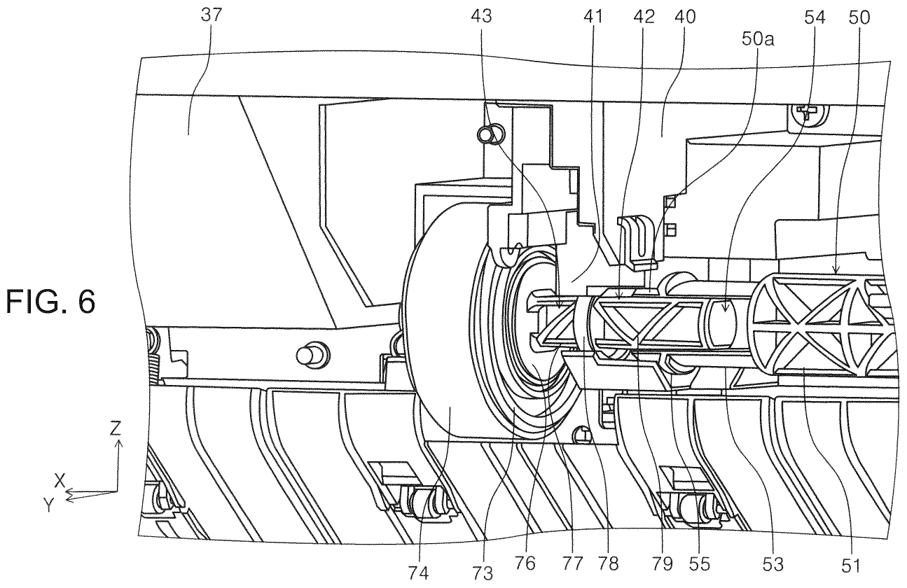

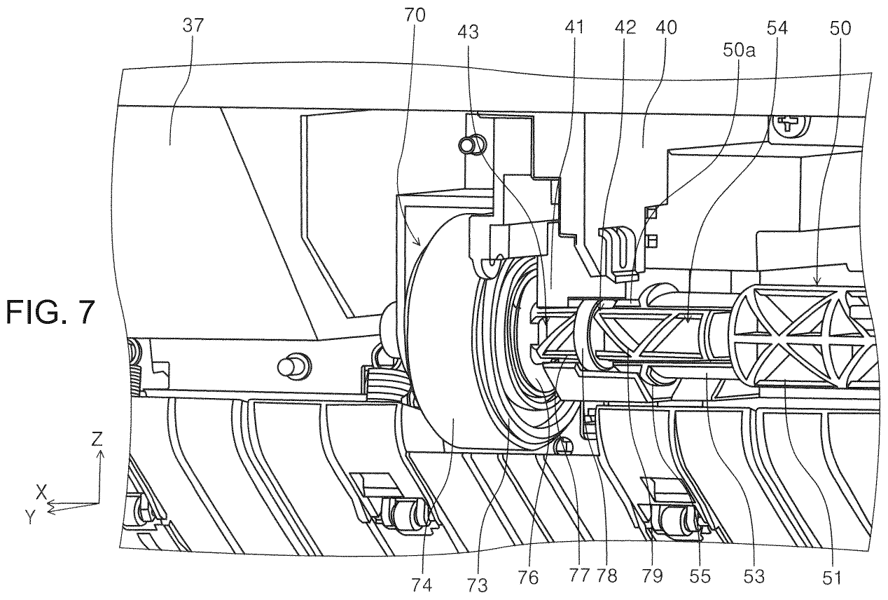

FIG. 6 shows a state where the restriction member 90 is removed. In this state, the feed roller 70 can be displaced from the attached position X1 to the attachment and detachment position X2. FIG. 7 illustrates a state in which the feed roller 70 has been displaced to the attachment and detachment position X2.

When the feed roller 70 is displaced to the attachment and detachment position X2, the sliding section 78 faces the first opening section 42, and the through shaft 75 is detached from the support hole 44 in the −X direction. When the feed roller 70 is displaced to the attachment and detachment position X2, the intermediate shaft section 77 moves to the shaft bearing section 41 and faces the second opening section 43.

Here, the sliding section 78 can be detached in the +Y direction via the first opening section 42 regardless of the rotational phase of the shaft section 72, but the intermediate shaft section 77 facing the second opening section 43 can be detached in the +Y direction via the second opening section 43, depending on the rotational phase of the shaft section 72 as described with reference to FIG. 10. FIG. 7 illustrates a state in which the intermediate shaft section 77 can be detached in the +Y direction through the second opening section 43.

In this state, since the attachment and detachment opening 54 of the cylinder section 53 also faces the +Y direction, the engagement shaft section 79 can also be detached from the cylinder section 53 in the +Y direction.

As described above, the feed roller 70 can be detached in the +Y direction in the state of FIG. 7. FIG. 8 illustrates a state in which the feed roller 70 has been removed.

Note that in a case where the feed roller 70 is to be attached, the feed roller 70 can be attached in the state of FIG. 8 by a procedure opposite to the one described above. That is, in the state of FIG. 8, the feed roller 70 is attached to the support member 40 and to the cylinder section 53 in the −Y direction, and is displaced from the attachment and detachment position X2 to the attached position X1. Then, the restriction member 90 is attached to the support member 40.

Note that as illustrated in FIGS. 6, 7, and 8, the rotational phase of the of the shaft section 72 includes a phase in which the shaft section 72 can be attached and detached and a phase in which the shaft section 72 cannot be attached and detached. In the feed standby state, the shaft section 72 is in the phase in which the shaft section 72 is attachable and detachable as illustrated in FIGS. 6, 7, and 8. The drive shaft 50 rotates once during medium feed, but returns to the phase illustrated in FIGS. 6, 7, and 8 when feed is completed.

Hereinafter, the operations and effects of the printer 1 having the above-described configuration will be described.

The feed roller 70 is displaceable along the axial direction to the attached position X1 and to the attachment and detachment position X2, which is located in the −X direction with respect to the attached position X1, and in a state where the feed roller 70 has been moved from the attached position X1 to the attachment and detachment position X2, the attachment and detachment direction of the feed roller 70 is a direction intersecting the axial direction. In the present embodiment, the attachment and detachment direction is a direction along the Y-axis direction.

By this, it is not necessary to provide a space for the feed roller 70 to come off to the outer side, that is, in the +X direction, of the feed roller 70 at the attached position X1 and thus it is possible to suppress an increase in the size of the device and to improve the flexibility of the layout.

For example, in the present embodiment, as illustrated in FIG. 2, a cover member 37 is provided on the outer side of, that is, in the +X direction of, the feed roller 70 located at the attached position X1. Components configuring the printer 1 can be disposed inside the cover member 37. For example, a pump (not illustrated) that generates a negative pressure in the cap section 26 (refer to FIG. 1) can be provided inside the cover member 37.

In the embodiment, when the feed roller 70 is positioned at the attached position X1, the feed roller 70 can be stably rotated because the sliding section 78 is supported by the shaft bearing section 41. In addition, in the embodiment, the through shaft 75 is axially supported by the support hole 44, the free end 50a of the drive shaft 50 is axially supported by the second bearing section 45 of the support member 40 and, by this, the rotation of the feed roller 70 is further stabilized.

Since the sliding section 78 moves from the bearing section 41 to a position facing the first opening section 42 in accordance with displacement of the feed roller 70 from the attached position X1 to the attachment and detachment position X2, the sliding section 78 can be detached through the first opening section 42.

In accordance with displacement of the feed roller 70 from the attached position X1 to the attachment and detachment position X2, the intermediate shaft section 77 moves to the bearing section 41 from a position that is deviated in the +X direction from the bearing section 41. The bearing section 41 has the second opening section 43 that is an opening that opens in the +Y direction, which is the detachment direction of the shaft section 72, and that has an opening width smaller than the diameter R2 of the sliding section 78. The opening width of the second opening section 43 is indicated by reference numeral W1 in FIG. 10.

The intermediate shaft section 77 is formed in a non-true circle shape so as to have a maximum diameter R3 and a minimum diameter D1 in cross section, and the opening width W1 of the second opening section 43 is smaller than the maximum diameter R3 of the intermediate shaft section 77 and larger than the minimum diameter D1 of the intermediate shaft section 77. By this, the intermediate shaft section 77 can be in a detachable state or in a non-detachable state depending on the rotational phase of the shaft section 72. As a result, it is possible to suppress the feed roller 70 that is located at the attachment and detachment position X2 from being unintentionally detached.

However, the maximum diameter R3 of the intermediate shaft section 77 may be smaller than the opening width W1 of the second opening section 43. By this, the intermediate shaft section 77 can be removed from the second opening section 43 regardless of the rotational phase of the shaft section 72. In this case, the cross section of the intermediate shaft section 77 may be formed in a true circle shape.

The drive shaft 50 has the cylinder section 53 into which the engagement shaft section 79 is fitted, and the cylinder section 53 has the attachment and detachment opening 54 that is open in a direction intersecting the axial direction. This facilitates attachment and detachment of the engagement shaft section 79 to and from the drive shaft 50.

Note that the engagement between the engagement shaft section 79 and the drive shaft 50 is not limited to simple insertion as in the present embodiment, and may be, for example, screw fixing.

The first linear section 79a and the second linear section 79b of the engagement shaft section 79 and the first restriction surface 56a and the second restriction surface 56b of the cylinder section 53 serve as rotation stoppers, so that the engagement shaft section 79 can appropriately receive torque from the cylinder section 53.

In the present embodiment, play between the intermediate shaft section 77 and the second opening section 43 when the intermediate shaft section 77 passes through the second opening section 43 in the attachment and detachment direction is larger than play between the cylinder section 53 and the engagement shaft section 79. The play between the intermediate shaft section 77 and the second opening section 43 is the difference between the opening width W1 and the minimum diameter D1 illustrated in FIG. 10. The play between the cylinder section 53 and the engagement shaft section 79 is the difference between the interval D2 and the minimum diameter D3 illustrated in FIG. 12.

When the opening direction of the attachment and detachment opening 54 and the opening direction of the second opening section 43 coincide with each other, the shaft section 72 can be attached and detached along the Y-axis direction, which is the attachment and detachment direction. Here, from the viewpoint of the cylinder section 53 transmitting torque to the engagement shaft section 79, it is desirable that play between the cylinder section 53 and the engagement shaft section 79 be as small as possible. However, in this case, if the play between the intermediate shaft section 77 and the second opening section 43 when the intermediate shaft section 77 passes through the second opening section 43 in the attachment and detachment direction is equal to or less than the play between the cylinder section 53 and the engagement shaft section 79, the shaft section 72 cannot be attached or detached unless the opening direction of the attachment and detachment opening 54 and the opening direction of the second opening section 43 strictly coincide with each other.

However, according to the present embodiment, since the play between the intermediate shaft section 77 and the second opening section 43 when the intermediate shaft section 77 passes through the second opening section 43 in the attachment and detachment direction is larger than the play between the cylinder section 53 and the engagement shaft section 79, the shaft section 72 can be attached and detached even when the opening direction of the attachment and detachment opening 54 and the opening direction of the second opening section 43 do not strictly coincide with each other, and the shaft section 72 can be easily attached and detached.

In the embodiment, the printer 1 includes the restriction member 90, which restricts displacement of the feed roller 70 from the attached position X1 to the attachment and detachment position X2. By this, it is possible to suppress the feed roller 70 from being inadvertently displaced from the attached position X1 to the attachment and detachment position X2 and coming off.

The restriction member 90 is attachable to and detachable from the support member 40.

Furthermore, the present disclosure is not limited to the embodiments and modifications described above, various modifications are possible within the scope of the disclosure described in the claims, it is needless to say that they are also included in the scope of the present disclosure.

For example, in the above-described embodiment, the roller attachment and detachment structure is applied to the feed roller 70, but may be applied to other rollers. If the other rollers are transport rollers, the present disclosure can be applied to a medium transport device.

What is claimed is:

1. A medium feed device comprising:
a placement section configured to have a medium placed thereon;
a feed roller configured to feed, in a feeding direction, the medium placed on the placement section;
a drive source of the feed roller;
a drive shaft that is a shaft configured to transmit drive force of the drive source to the feed roller, that extends along a width direction intersecting the feeding direction, that has a free end; and
a support member configured to rotatably support the feed roller, wherein
the feed roller is provided at the free end of the drive shaft,
a direction that is along an axial direction of the drive shaft and that is from a base end side of the drive shaft toward the free end is defined as a first direction, and a direction opposite to the first direction is defined as a second direction,
the feed roller is configured to be displaceable along the axial direction between an attached position and an attachment and detachment position that is located in the second direction with respect to the attached position, and
in a state where the feed roller has been moved from the attached position to the attachment and detachment position, an attachment and detachment direction of the feed roller is a direction intersecting the axial direction.

2. The medium feed device according to claim 1, wherein
the feed roller includes
a roller section configured to come into contact with the medium and
a shaft section that is located in the second direction with respect to the roller section, that extends in the width direction, and that engages with the drive shaft,
the shaft section includes
an intermediate shaft section having a diameter smaller than that of the roller section,
a sliding section that is located in the second direction from the intermediate shaft section and that has a larger diameter than the intermediate shaft section, and
an engagement shaft section that is located in the second direction from the sliding section, that has a smaller diameter than the sliding section, and that extends in the second direction,
the drive shaft is configured to transmit the drive force to the engagement shaft section the support member includes
a bearing section that rotatably supports the sliding section and
a first opening section that is located in the second direction from the bearing section, that opens in a detachment direction of the shaft section, and that has an opening width larger than the diameter of the sliding section, and
the sliding section is configured to move from the bearing section to a position facing the first opening section in accordance with displacement of the feed roller from the attached position to the attachment and detachment position.

3. The medium feed device according to claim 2, wherein
the intermediate shaft section is configured to move from a position separated in the first direction from the bearing section to the bearing section in accordance with displacement of the feed roller from the attached position to the attachment and detachment position,
the bearing section has a second opening section that is an opening section opening in the detachment direction of the shaft section and that has an opening width smaller than the diameter of the sliding section, and
the intermediate shaft section has a non-true circle shape so as to have a maximum diameter and a minimum diameter in cross section, and the opening width of the second opening section is smaller than the maximum diameter of the intermediate shaft section and larger than the minimum diameter of the intermediate shaft section.

4. The medium feed device according to claim 3, wherein
the drive shaft includes a cylinder section into which the engagement shaft section is fitted and
the cylinder section has an attachment and detachment opening that opens in a direction intersecting the axial direction.

5. The medium feed device according to claim 4, wherein
an outer periphery of the engagement shaft section includes in cross section
a first linear section and
a second linear section that is parallel to the first linear section,
an inner side of the attachment and detachment opening includes
a first restriction surface that is a surface that faces the first linear section of the engagement shaft section and
a second restriction surface that is a surface that faces the second linear section of the engagement shaft section, and
the first restriction surface and the second restriction surface transmit torque to the engagement shaft section.

6. The medium feed device according to claim 5, wherein
play between the intermediate shaft section and the second opening section when the intermediate shaft section passes through the second opening section in the attachment and detachment direction is larger than play between the cylinder section and the engagement shaft section.

7. The medium feed device according to claim 1, further comprising:
a restriction member configured to restrict displacement of the feed roller from the attached position to the attachment and detachment position.

8. The medium feed device according to claim 7, wherein
the restriction member is attachable to and detachable from the support member.

9. A recording device comprising:
the medium feed device according to claim 1 and a recording section that performs recording on the medium fed by the medium feed device.
